(19) United States
(12) Patent Application Publication
(10) Pub. No.: US 2025/0250852 A1
(43) Pub. Date: Aug. 7, 2025

(54) TENSIONING DEVICE

(71) Applicant: ROLLEASE ACMEDA, INC., Stamford, CT (US)

(72) Inventor: Alirio E. Guerra, Broadmeadows (AU)

(21) Appl. No.: 19/036,404

(22) Filed: Jan. 24, 2025

(30) Foreign Application Priority Data
Feb. 7, 2024 (AU) 2024900281
Jul. 26, 2024 (AU) 2024902326

(51) Int. Cl. E06B 9/42; A47H 3/08; E06B 9/78

(52) U.S. Cl. CPC E06B 9/42; A47H 3/08; E06B 9/78; E06B 2009/785

(57) ABSTRACT

A tensioning device comprising a guide adapted to receive thereabout one end of a looped operating element (“LOE”), a retainer configured to prevent said one end from traveling about the guide, the guide and retainer being configured to move relative one another between first and second positions; a biasing element for biasing the guide towards the retainer to tension the LOE. In the first position, the LOE has no tension and the guide is extended to trap said one end between the guide and the retainer to prevent travel of the LOE about the guide. In the second position, the LOE is tensioned with the guide being retracted from the retainer, and a locking device for locking the guide in the first position when the LOE has no tension such that the guide cannot be retracted away from the retainer to allow operation of the operating element.

### Cross-Reference to Related Applications

This application claims priority to and the benefit of the filing date of Australian Provisional Patent Application No. 2024900281, filed Feb. 7, 2024, and Australian Provisional Patent Application No. 2024902326, filed Jul. 26, 2024, each entire disclosure of which is hereby incorporated herein by reference.

### TECHNICAL FIELD

The present disclosure relates to a tensioning device for an operating element of an architectural covering such a blind, curtain or the like.

### BACKGROUND ART

Many types of architectural coverings for windows, doors and the like, include an actuator in the form of looped operating element. The element includes an upper end that engages around a rotatable drive of the covering. The drive operates to extend and retract a covering material, for example a curtain, blind or the like. Rather than a lower end of the element hanging freely and being a strangulation risk to children, a tensioning device is typically utilised to allow the looped element to be pulled tight such that it is difficult to spread the two sides of the looped element apart. In this regard, tensioning devices typically include a passage for the lower end of looped element and a means to enable the tensioning device to be mounted to a wall or surrounding frame of an architectural opening.

Most tensioning devices are spring loaded to keep the operating element under tension. The spring length provides enough travel for some stretching of the operating element due to normal operation and allows for positioning errors while maintaining some operating element tension. A typical tensioning device consists of a body, a plunger (or guide/pulley) and a spring (compression or extension depending on the design). A tensioning device is installed with the operating element under tension.

An operating element, for example a looped bead chain, may stretch over the operational life of the blind to the point that tension is reduced or lost. Alternatively, a tensioning device may be installed incorrectly, i.e., the bead chain has little or no tension. Under either of these tension loss conditions, the spring-loaded plunger may push and force the bead chain against a retainer to mitigate bead chain movement and blind covering operation. However, it is possible to override this locking feature in known tension devices to operate the window covering when the bead chain is not tensioned. More specifically, known tensioning devices can be defeated (i.e., the blind covering can still be operated) by applying simultaneous hand tension and pulling action to the bead chain (by pulling the bead chain towards the user) such that the spring-loaded plunger is lifted away from the bead chain locking element, thus freeing up the bead chain and allowing a user to move the shade up and down. Upon release of the bead chain, tension is lost again, and a hazardous loop may be formed which poses a strangulation hazard for children.

It would be desirable to provide a tensioning device which has one or more improved features.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

In accordance with a first aspect of the present disclosure, there is provided a tensioning device for a looped operating element of an architectural covering, the tensioning device being configured to selectively lock the operating element in a position relative to the tensioning device, the tensioning device comprising:
a body configured to house one end of the looped operating element, the body being mountable to a fixed structure adjacent the architectural covering,
a guide adapted to receive thereabout said one end of the looped operating element, the guide being configured to move relative to the body between first and second positions;
a retainer configured to prevent said one end of the looped operating element from traveling about the guide,
a biasing element for biasing the guide towards the retainer to tension the looped operating element,
wherein in the first position, the looped operating element has no tension and the guide is extended to trap said one end of the looped operating element between the guide and the retainer to prevent travel of the looped operating element about the guide, and in the second position, the looped operating element is tensioned with the guide being retracted from the retainer,
and a locking device for locking the guide in the first position when the looped operating element has no tension such that the guide cannot be retracted away from the retainer to allow operation of the operating element.

The locking device may include a first locking pin housed within a recess of the guide, and the body may include a first receiving aperture, the first locking pin being configured to project into the first receiving aperture when the guide is in the first position to lock the guide relative to the body.

The receiving aperture may extend through a rear housing of the body, the first locking pin being releasable from the first receiving aperture by pushing the first locking pin from a rear of the body out of the first receiving aperture thereby releasing the guide from locked engagement with the rear housing.

The locking device may further include a second locking pin housed within the recess of the guide, and the body comprises a second receiving aperture, the second locking pin being configured to project into the second receiving aperture when the guide is in the first position to lock the guide relative to the body.

The second receiving aperture may extend through a front housing of the body, the second locking pin being releasable from the second receiving aperture by pushing the second locking pin from a front of the body out of the second receiving aperture thereby releasing the guide from locked engagement with the front body.

The rear housing can be mountable against the fixed structure such that in use, the first receiving aperture is hidden from view and is not accessible to a user.

The locking device may further include a spring member within the recess, the spring member being configured to bias the first locking pin towards the first receiving aperture. The spring member within the recess may also be configured to bias the second locking pin towards the second receiving aperture.

The retainer may be mounted to the body between the rear housing and a front housing of the body.

The locking device may include a pawl formed as part of the guide and a toothed structure formed as part of the body, the pawl being configured to pass over the toothed structure when the guide moves towards the retainer to maintain tension in the operating element as the operating element stretches in use, the toothed structure restricting reverse movement of the guide away from the retainer.

The operating element may be a beaded chain and the retainer may be a member which includes a trench that is sized and configured to receive the chain, the trench having a narrowing region for supporting links between adjacent beads when the guide is in the first position to prevent travel of the beaded chain.

The operating element may be a cord and the guide may include a rotatable component mounted to a main body of the guide, the rotatable component may be configured to receive thereabout the cord. Further, the retainer may be a rotatable element mounted to the body, the rotatable element and rotatable component being configured to grip the cord therebetween when the guide is in the first position to prevent travel of the cord.

In one form, the rotatable component is an eccentric guide wheel rotatably mounted to the main body of the guide and the rotatable element is an eccentric retaining wheel rotatably mounted to the body.

In accordance with another aspect of the invention, there is provided a tensioning device for a looped operating element of an architectural covering, the tensioning device being configured to selectively lock the operating element in a position relative to the tensioning device, the tensioning device including:
a body configured to house one end of the looped operating element,
a guide mounted to the body and adapted to receive thereabout one end of the looped operating element,
a retainer configured to prevent said one end of the looped operating element from traveling about the guide, the retainer being mountable to a fixed structure adjacent the architectural covering, the guide and body being configured to move relative to the retainer between first and second positions;
a biasing element for biasing the guide towards the retainer to tension the looped operating element,
wherein in the first position, the looped operating element has no tension and the guide traps said one end of the looped operating element between the guide and the retainer to prevent travel of the looped operating element about the guide, and in the second position, the looped operating element is tensioned with the guide being moved away from the retainer,
and a locking device for locking the guide and body in the first position when the looped operating element has no tension such that the guide cannot be moved away from the retainer to allow operation of the operating element.

The locking device may form part of either the guide or the retainer.

### BRIEF DESCRIPTION OF DRAWINGS

Various embodiments/aspects of the disclosure will now be described with reference to the following figures.

FIG. 1 is a perspective view of an architectural covering in the form of a retractable blind with a looped operating element in the form of a beaded chain that is secured at a lower end to a tensioning device in accordance with an embodiment of the present disclosure;

FIG. 2A is an exploded front perspective view of the components of the tensioning device shown in FIG. 1 according to a first embodiment of the present disclosure;

FIG. 2B is an exploded rear perspective view of the components of the tensioning device of the first embodiment illustrated in FIG. 2A;

FIG. 3A is a sectional view of the tensioning device of the first embodiment illustrated in FIG. 2A showing the guide in the first (locked) position;

FIG. 3B is a side sectional view of the tensioning device of the first embodiment illustrated in FIG. 3A;

FIG. 3C is a rear perspective view of the tensioning device of the first embodiment illustrated in FIG. 3A;

FIG. 4A is a sectional view of the tensioning device of the first embodiment illustrated in FIG. 2A showing the guide in a second (unlocked) position;

FIG. 4B is a side sectional view of the tensioning device of the first embodiment illustrated in FIG. 4A;

FIG. 4C is front perspective view of the tensioning device of the first embodiment illustrated in FIG. 4A;

FIG. 5A is a perspective view of the retainer and guide of the tensioner of the first embodiment in the first position illustrated in FIGS. 3A-3C with the beaded chain positioned therebetween;

FIG. 5B is perspective view of the retainer and beaded chain illustrated in FIG. 5A with the guide omitted;

FIG. 5C is perspective view of the retainer of the tensioning device of the first embodiment illustrated in FIGS. 2A-4C;

FIG. 6A is an exploded front perspective view of the components of the tensioning device according to a second embodiment of the present disclosure which is particularly suited for a looped operating element in the form of a cord;

FIG. 6B is an exploded rear perspective view of the components of the tensioning device of the second embodiment illustrated in FIG. 6A;

FIG. 7A is a sectional view of the tensioning device of the second embodiment illustrated in FIG. 6A showing the guide in a second (unlocked) position;

FIG. 7B is a side sectional view of the tensioning device of the second embodiment illustrated in FIG. 7A;

FIG. 7C is front perspective view of the tensioning device of the second embodiment illustrated in FIG. 7A;

FIG. 8A is a sectional view of the tensioning device of the second embodiment illustrated in FIG. 6A showing the guide in the first (locked) position;

FIG. 8B is a side sectional view of the tensioning device of the second embodiment illustrated in FIG. 8A;

FIG. 8C is a front perspective view of the tensioning device of the second embodiment illustrated in FIG. 8A, and

FIGS. 9A, 9B and 9C are partial views of the tensioning device of the second embodiment showing the progression of interference on the cord as the guide wheel and retaining wheel rotate.

### DETAILED DESCRIPTION

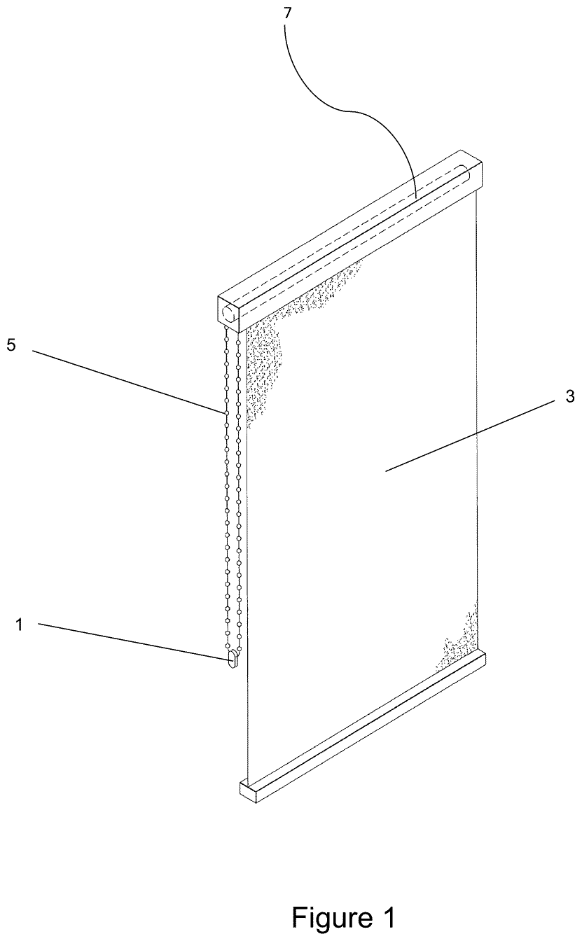

Referring firstly to FIG. 1, there is disclosed a tensioning device 1 for an operating element of an architectural covering, for example a curtain or a blind having a retractable shade 3. The operating element hangs to facilitate operation by a user and may be in the form of a looped beaded chain 5 (as illustrated in FIG. 1) or a looped cord 6. The operating element is operably connected to a drive means (not shown) of the blind to retract and extend the retractable shade 3. The beaded chain loop 5 version of the operating element typically comprises a plurality of connected beads (e.g. round metal or plastic beads) that are connected at either end to form a continuous loop of beads. The looped cord 6 version of the operating element is relatively thin and made for example of strands of fibres twisted or braided together.

In a typical form, the blind includes an elongate rod 7 for supporting the retractable shade 3 (e.g. a length of fabric). First and second ends of the rod are typically configured to support the blind (e.g. on either side of a window). The drive means is typically connected to the rod 7 and is configured to rotate the rod 7 about a longitudinal axis of the rod 7 to extend and retract the retractable shade 3 in use. The looped operating element extends along a longitudinal axis of the element (typically this axis is substantially perpendicular to the longitudinal axis of the rod 7) between proximal and distal ends. The proximal end of the operating element is connected to the drive means of the blind such that a user is able to operate the operating element to retract and extend the retractable shade 3.

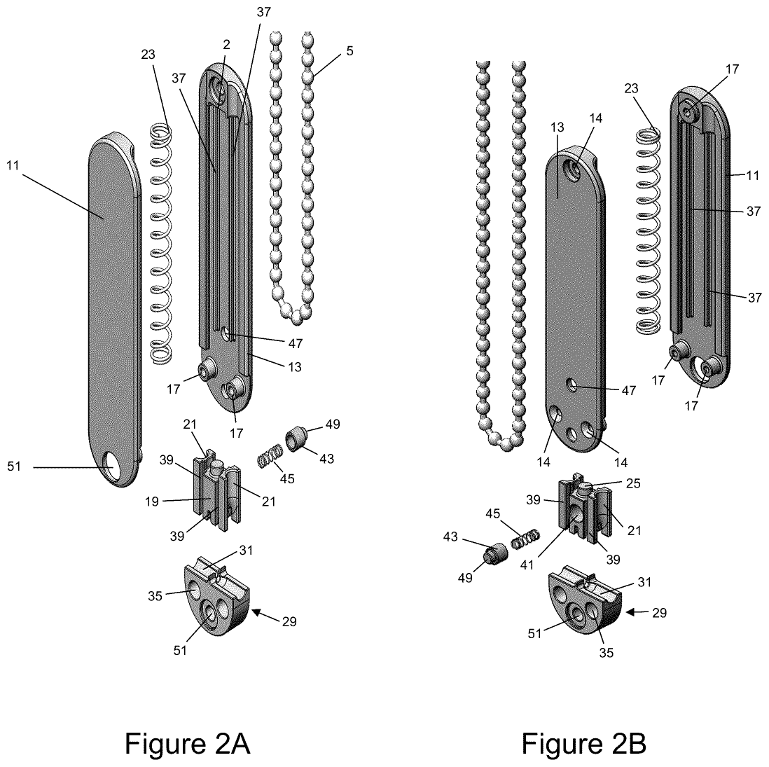

A tensioning device 1 in accordance with a first embodiment, which is specifically suited for the beaded chain loop 5 version of the operating element, will now be described in detail with reference to FIGS. 1 to 5C. The tensioning device 1 includes an elongate body 9 (single or multi-piece construction) within which the proximal or lower end of the chain loop 5 remote from the blind may be housed. The body 9 preferably includes a front housing 11 and a rear housing 13 which are secured together, for example with one or more fasteners 15, as best illustrated in FIGS. 2B, 3B and 4B. The rear housing 13 includes one or more apertures 14 through which fasteners 15 may pass into threaded holes 17 of the front housing 11. Between the front housing 11 and rear housing 13 is contained a guide 19 which includes an arcuate channel 21 which extends around an underside of the guide 19 and up both side edges of the guide 19. The channel 21 is sized to receive thereabout the lower end portion of the chain loop 5.

The tensioning device 1 may further include a biasing element which may be in the form of a spring member 23, for example a coil spring, such that the guide 19 is spring loaded. The guide 19 includes a tab 25 projecting from a top side of the guide 19 over which one end of the spring member 23 may seat to connect the guide 19 to the spring member 23. An opposite end of the spring member 23 may seat on an inner surface 2 at an upper end of the body 9 where the front housing 11 and rear housing 13 join.

The tensioning device 1 further includes a retainer which in the illustrated first embodiment of the tensioning device 1 may be in the form of a member 29 housed between the front housing 11 and the rear housing 13 at a lower end of the body 9. In another form the member 29 may be integrally formed with the body 9, for example fully incorporated into either the front housing 11 or the rear housing 13. In another form, part of the member 29 may be incorporated into each half of the rear and the front housings. The member 29 functions to impede the looped beaded chain 5 from traveling along the channel 21 of the guide 19 when the looped beaded chain 5 is not in a taut condition (i.e. not under tension). This can be due to stretching of the beaded chain 5 or the tensioning device 1 not being mounted correctly, for example, if the tensioning device 1 is hanging freely and/or not properly anchored to a fixed structure adjacent the architectural covering such that there is tension in the beaded chain 5.

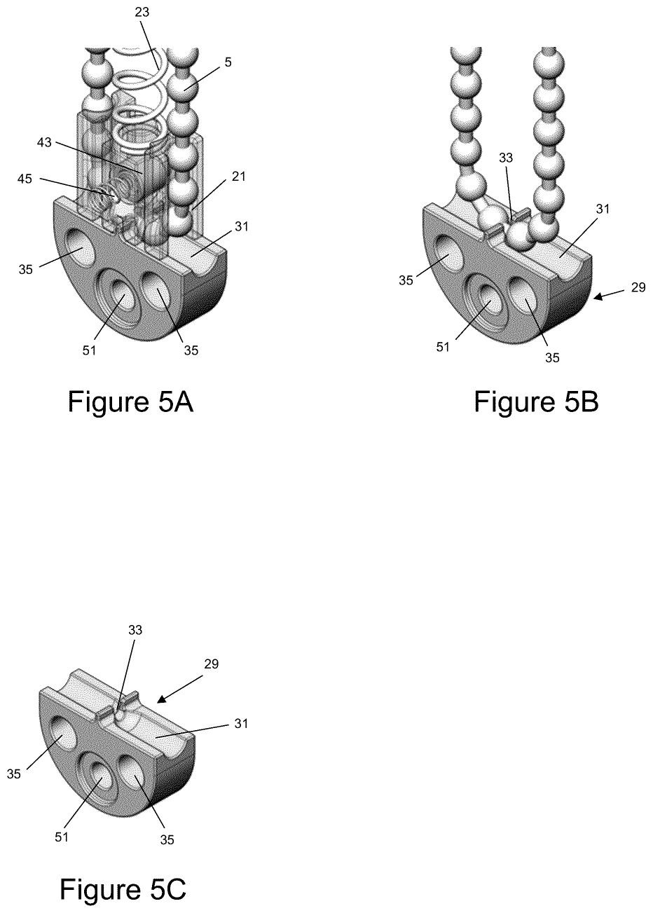

The member 29 may be specifically designed to work with either a looped beaded chain 5 or a looped cord, or may be designed such that it is operative for both forms of operating element. In one form, the member 29 includes a trench 31 which extends along the top of the member 29 into which the operating element may seat when pressed into engagement with the member 29 by the guide 19. When the operating element is in the form of a beaded chain 5, the trench 31 may include a centrally located narrowing region 33 which is sized to only accommodate the link between adjoining beads of the chain, as best illustrated in FIGS. 5A, 5B and 5C. In another embodiment, the trench 31 may include a multiple number of narrowing regions 33 which are spaced apart the same distance as the links between the beads. When the operating element is instead in the form of a cord, the top of the member 29 may have a serrated surface instead of a trench 31 to enable the cord to be gripped by the member 29 when pressed into engagement with the member 29 by the guide 19. The serrated surface may be in the form of a separate component, (for example an eccentric serrated cam) with a matching component provided in the guide 19. Alternatively, the member 29 may have serrations on the surface of the trench 31 for the same purpose. In one embodiment, the member 29 may further include a pair of openings 35 which extend through the member 29. The pair of openings 35 align with apertures 14 in the rear housing 13 and threaded holes 17 in the front housing 11 such that the member 29 can be secured in place between the front and rear housing 11, 13 with fasteners.

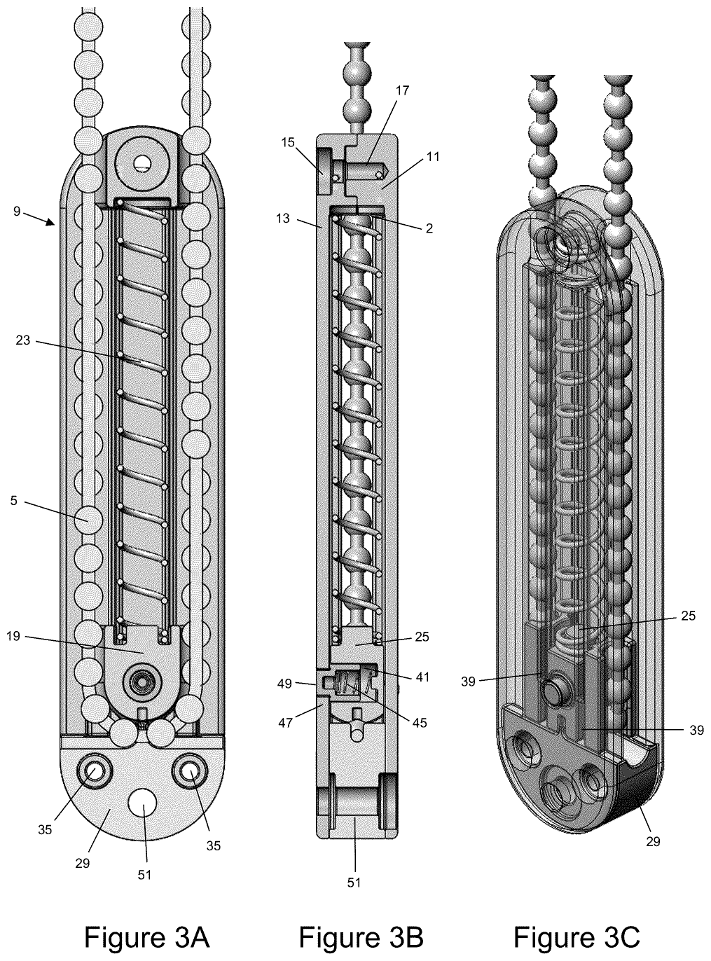

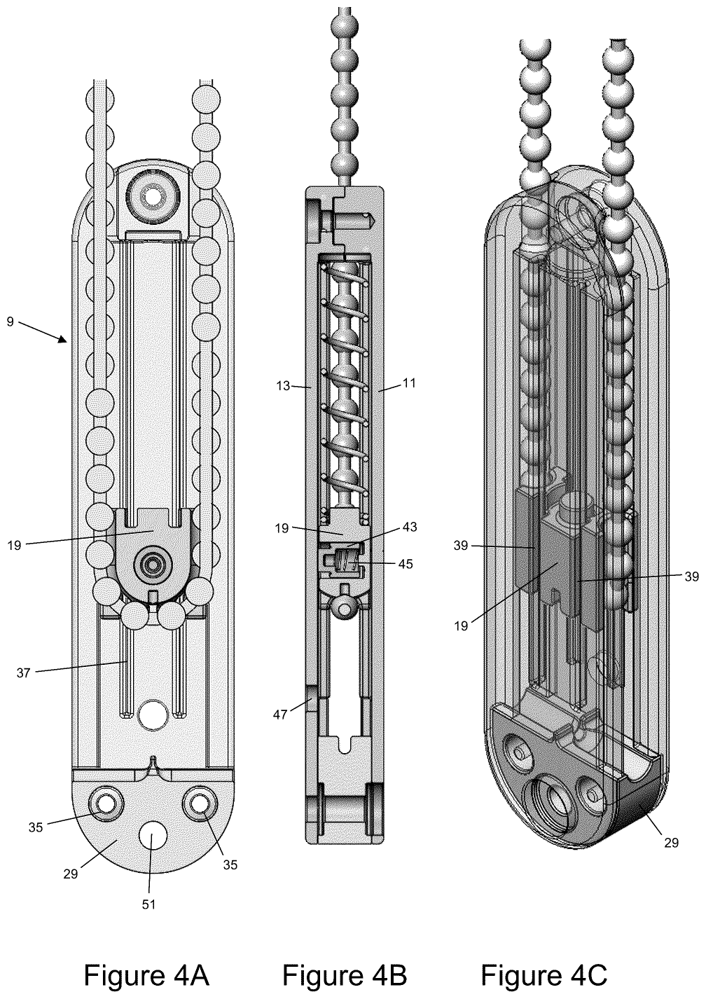

As best illustrated in FIGS. 2A and 2B, the front housing 11 and the rear housing 13 each include a pair of projecting tracks 37 which engage in corresponding grooves 39 provided in front and rear faces of the guide 19 to limit the guide 19 to sliding movement within the body 9. The rear face of the guide 19 faces towards the rear housing 13 and includes a recess 41 which forms part of a locking device of the tensioning device 1. In one embodiment (the single ended locking pin embodiment), the locking device includes a first locking pin 43 and a resilient member 45 within the recess 41 such that the first locking pin 43 is spring loaded. The first locking pin 43 is biased into abutment with the rear housing 13 by the resilient member 45 and slides along the rear housing 13 as the guide 19 travels along the tracks 37, as best illustrated in FIG. 4B. The rear housing 13 includes a first receiving aperture 47 into which a head portion 49 of the first locking pin 43 is received, as best illustrated in FIG. 3B, when the guide 19 is in a fully extended first position. In an alternative form of the single locking pin arrangement (not illustrated), the locking action occurs with the front housing 11 rather than the rear housing 13. More specifically, the front face of the guide 19 includes the recess within which is housed the first locking pin and resilient member. The first locking pin is biased into abutment with the front housing 13 by the resilient member and slides along the front housing 13 as the guide 19 travels along the tracks 37. The front housing 11 rather than the rear housing 13 includes the first receiving aperture into which the head portion of the first locking pin is received when the guide 19 is in the fully extended first position.

In yet another embodiment (the double ended locking pin embodiment, not illustrated), the locking device is a double-ended locking configuration in which the recess 41 is a thru-hole in the guide 19 and the locking device includes a second locking pin at an opposite end of the recess 41 to the first locking pin 43. The second locking pin is spring biased by the resilient member 45 to project out of the front face of the guide 19 and into abutment with the front housing 11. The front housing 11 may include a second receiving aperture into which a head portion of the second locking pin is received when the guide 19 is in a fully extended first position. The double ended locking pin being releasable from the receiving apertures when the guide 19 is in the first position to lock the guide 19 relative to the body 9. The head portion of the second locking pin is visible from the front housing 11 when the second locking pin is in the second receiving aperture and may serve as an indicator to a user that the tensioner 1 is locked. Pressing only one end of the double ended locking pin will not release the guide 19, thus requiring simultaneous pressing of each end of the double ended locking pin, ie both the first and second locking pins, to release the guide 19 from locked engagement with the body 9.

In order to mount the tensioning device 1 for operation, a mounting aperture 51 is provided through at least the body 9 of the tensioning device 1. In one form, an aligned mounting aperture 51 is provided through a lower portion of the front housing 11, the rear housing 13 and the member 29 such that a fastener, for example a screw, can be inserted to secure the tensioning device 1 to a wall or surrounding frame of the architectural opening. In use, the tensioning device 1 is preferably mounted such that the rear housing 13 of the device 1 abuts with the wall or surrounding frame to thereby prevent the first locking pin 49 and first receiving aperture 47 being accessed from the rear of the device 1.

When the guide 19 is in the first position, illustrated in FIGS. 3A, 3B and 3C, the guide 19 is fully extended and traps the proximal end of the looped beaded chain 5 between the guide 19 and the member 29 to prevent the looped beaded chain 5 from being able to travel about the guide 19 to operate the drive means of the blind. The guide 19 is in this fully extended first position when there is no tension in the looped beaded chain 5 to hold the guide 19 back from being pushed by the spring member 23 to extend fully to engage with the member 29. For example, the beaded chain 5 may have stretched over a period of time to the point that beaded chain tension is lost. Furthermore, in this first position, the tensioning device 1 cannot be defeated, for example by applying simultaneous hand tension and a pulling action to the bead chain 5 (by pulling bead chain towards the user) to lift the spring-loaded guide 19 away from the member 29, as the guide 19 is locked in position by the first locking pin 43 being engaged in the first receiving aperture 47 of the rear housing 13. The only way the first locking pin 43 can be released from the first receiving aperture 47 is by removing the tensioning device 1 from its mounting such that access to the first receiving aperture 47 can be obtained. In this respect, a slender pointed implement, for example a suitably sized screwdriver, is required to push the head portion 49 of the first locking pin 43 back into the recess 41 in the guide 19 until the head portion 49 is clear of the rear housing 13. With the head portion 49 clear, the looped beaded chain 5 can then be lifted away from the tensioning device 1 to pull the guide 9 back from the retainer 29.

In a normal operating position with the tensioning device 1 mounted, the guide 19 is in a second position, illustrated in FIGS. 4A, 4B and 4C, in which the guide 19 is spaced from the member 29 and maintains the beaded chain loop 5 under tension by virtue of the guide 19 being biased. The spring loaded guide 19 constantly pulls the beaded chain loop 5 towards the member 29 to keep the beaded chain loop 5 under tension. As the looped beaded chain 5 stretches over time, the guide 19 gradually slides along the tracks 37 towards the member 29 to maintain tension on the looped beaded chain 5.

Applying a lateral pull force on the looped beaded chain 5 above the tensioning device 1 results in the guide 19 moving further away from the member 29 and returning to its last location when the member 29 is released. The amount of lateral movement of the beaded chain 5 between the tensioning device 1 and the drive means depends on the allowable movement of the guide 19 and on the amount of stretch of the beaded chain 5. It is desirable that reverse movement of the guide 19 be restricted to minimize the lateral movement of the beaded chain 5. In this respect, excessive lateral movement of the beaded chain 5 may result in the formation of a hazardous loop which poses a strangulation risk to children.

A tensioning device 1 in accordance with a second embodiment, which is specifically suited for a cord operating element 6, will now be described in detail with reference to FIGS. 1 and 6A to 9C in which the same reference numerals are used to designate like features from the first embodiment. The tensioning device 1 includes an elongate body 9 (single or multi-piece construction) within which the proximal or lower end of the cord 6 remote from the blind may be housed. The body 9 preferably includes a front housing 11 and a rear housing 13 which are secured together, for example by a snap fit action and/or one or more fasteners. The rear housing 13 may include one or more apertures 14 through which fasteners may pass into holes 17 of the front housing 11. A guide 19 is disposed between the front housing 11 and rear housing 13. The guide 19 includes a main body 20 having a pair of opposing legs 22, and a rotatable component, for example an eccentric guide wheel 24, which is housed between two opposing legs 22. The guide wheel 24 is mounted for rotational motion and is held in position by a guide pin 26 which extends through an aperture in the guide wheel 24 and two opposing legs 22. The eccentric guide wheel 24 is free to rotate about the guide pin 26 and is configured to receive thereabout a portion of the cord 6. In another embodiment, the rotatable component may be of a shape other than circular, and/or may not be eccentric but still provide the same functionality.

The tensioning device 1 may further include a biasing element which may be in the form of a spring member 23, for example a coil spring, such that the guide 19 is spring loaded. The main body 20 of the guide 19 includes a tab 25 projecting from a top side of the main body 20 over which one end of the spring member 23 may seat to connect the guide 19 to the spring member 23. An opposite end of the spring member 23 may seat on an inner surface 2 at an upper end of the body 9 where the front housing 11 and rear housing 13 join.

The tensioning device 1 in accordance with the second embodiment further includes a retainer which is preferably in the form of a rotatable element, for example an eccentric retaining wheel 28, held in place between the front and rear housing 11, 13 by a retaining pin 30 about which the retaining wheel 28 is able to rotate. In other embodiments, the rotatable element may be of a shape other than circular and/or may not be eccentric, but still provide the same functionality. In yet a further embodiment, the retainer may be fixed, ie non-rotatable. The retaining wheel 28 functions to impede the looped cord 6 from traveling about the guide wheel 24 when the looped cord 6 is not in a taut condition (i.e. not under tension). This can be due to stretching of the cord 6 or the tensioning device 1 not being mounted correctly, for example, if the tensioning device 1 is hanging freely and/or not properly anchored to a fixed structure adjacent the architectural covering such that there is tension in the cord 6.

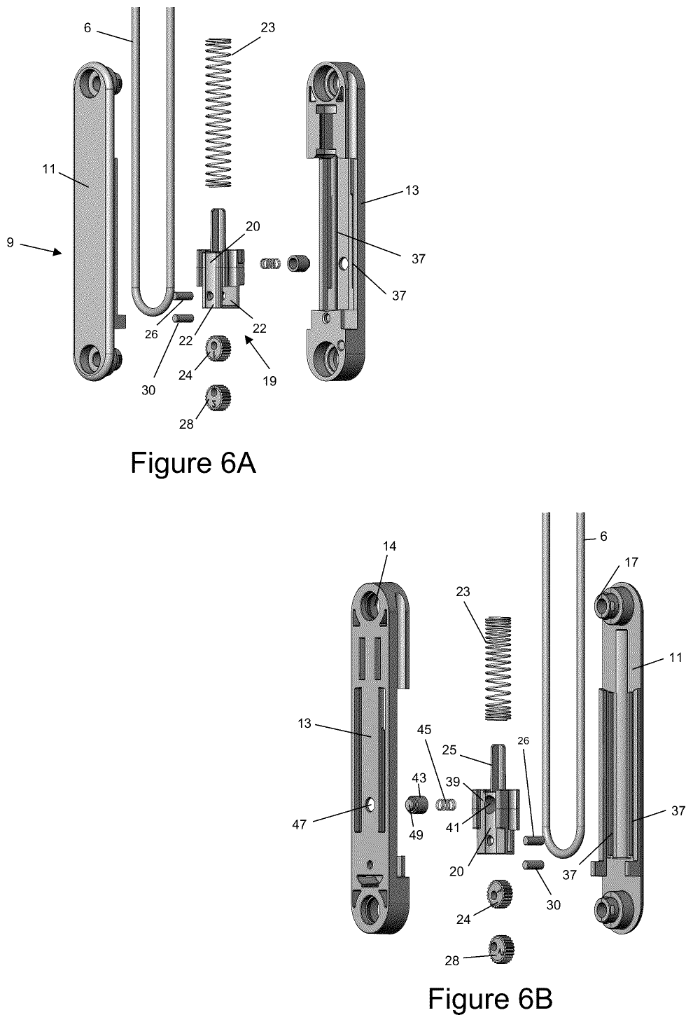

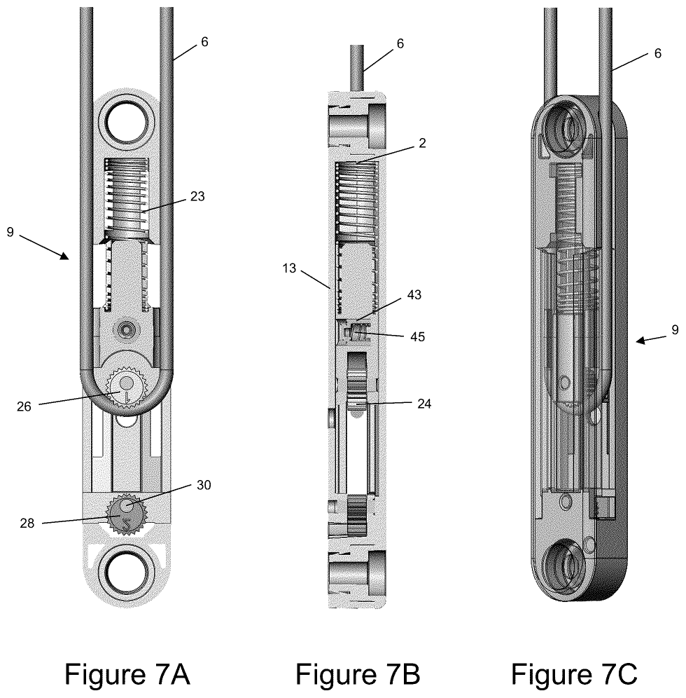

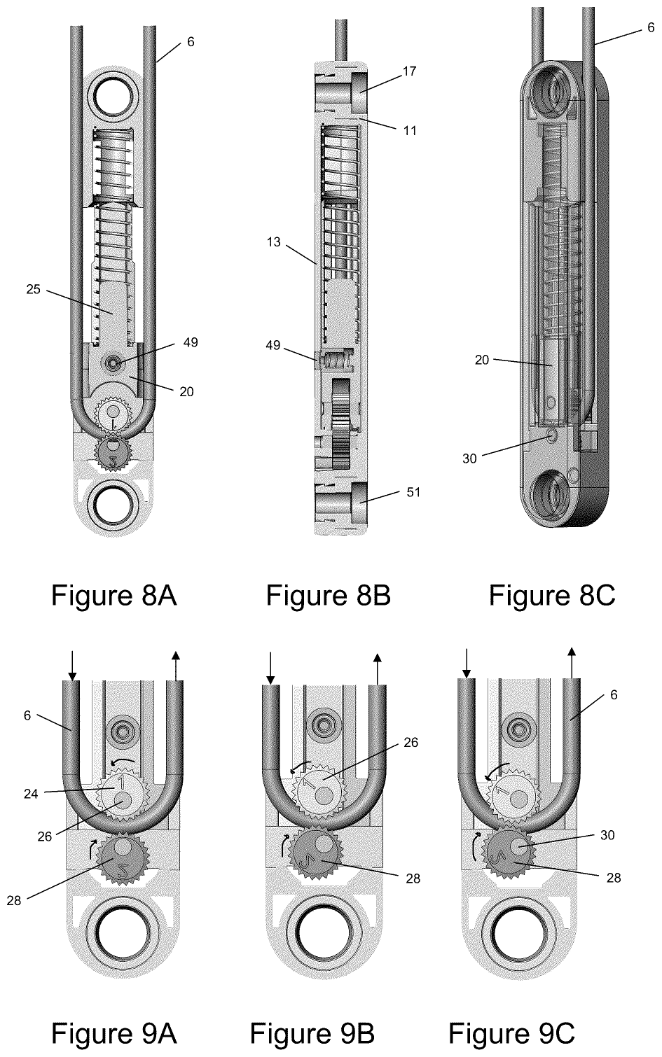

As is best illustrated in FIGS. 6A and 6B, the front housing 11 and the rear housing 13 each include one or more tracks 37 which engage with corresponding grooves 39 provided in the main body 20 of the guide 19 to limit the guide 19 to sliding movement within the body 9. The rear face of the main body 20 of the guide 19 faces towards the rear housing 13 and includes a recess 41 which forms part of the locking device of the tensioning device 1. The locking device includes at least a first locking pin 43 and a resilient member 45 within the recess 41 such that the first locking pin 43 is spring loaded. The first locking pin 43 is biased into abutment with the rear housing 13 by the resilient member 45 and slides along the rear housing 13 as the guide 19 travels along the tracks 37, as best illustrated in FIG. 7B. The rear housing 13 includes a first receiving aperture 47 into which a head portion 49 of the first locking pin 43 is received, as best illustrated in FIG. 8B, when the guide 19 is in a fully extended first position. In an alternative form of the single locking pin arrangement (not illustrated), the locking action occurs with the front housing 11 rather than the rear housing 13. More specifically, the front face of the main body 20 of the guide 19 includes the recess within which is housed the first locking pin and resilient member. The first locking pin is biased into abutment with the front housing 13 by the resilient member and slides along the front housing 13 as the guide 19 travels along the tracks 37. The front housing 11 rather than the rear housing 13 includes the first receiving aperture into which the head portion of the first locking pin is received when the guide 19 is in the fully extended first position.

The double ended locking pin embodiment described above in paragraph may also apply to the cord operated version of the tensioning device 1. In this regard, the recess 41 may be a thru-hole in the main body 20 of the guide 19 and the locking device may include a second locking pin (not illustrated) at an opposite end of the recess 41 to the first locking pin 43. The second locking pin may be spring biased by the resilient member 45 to project out of the front face of the main body 20 and into abutment with the front housing 11. The front housing 11 may include a second receiving aperture (not illustrated) into which a head portion of the second locking pin is received when the guide 19 is in a fully extended first position. The double ended locking pin being releasable from the receiving apertures when the guide 19 is in the first position to lock the guide 19 relative to the body 9. The head portion of the second locking pin may be visible from the front housing 11 when the second locking pin is in the second receiving aperture and may serve as an indicator to a user that the tensioner 1 is locked. Pressing only one end of the double ended locking pin will not release the guide 19, thus requiring simultaneous pressing of each end of the double ended locking pin, ie both the first and second locking pins, to release the guide 19 from locked engagement with the body 9.

To mount the tensioning device 1 for operation, one or more mounting apertures 51 is provided through at least the body 9 of the tensioning device 1. In one form, an aligned mounting aperture 51 is provided through a lower portion of the front housing 11 and the rear housing 13 such that a fastener, for example a screw, can be inserted to secure the tensioning device 1 to a wall or surrounding frame of the architectural opening. When the tensioning device 1 is installed correctly, the cord 6 is under tension and runs in contact with the guide wheel 24. As the cord 6 is moved to operate the shade, the guide wheel 24 rotates.

The guide is biased towards the first position by the spring member 23. When there is no tension on the cord 6, the guide will reach the first position—illustrated in FIGS. 8A to 8C. When in this first position, the first locking pin 43 is biased into the first receiving aperture in the rear housing. With the first locking pin 43 in this position, the main body 20 of the guide can no longer move. In contrast, when tension exists on the cord 6 during normal operation, the sliding guide will sit in an intermediate (second) position above the first position, which is illustrated in FIGS. 7A-7C. When it is in this intermediate (second) position, the guide can slide freely up and down, and its position is dictated by the force of the spring member 23 and the tension on the cord 6.

The guide 19 moves to the fully extended first position, illustrated in FIGS. 8A to 9C, when there is no tension in the cord 6 to hold the guide 19 back from being pushed by the spring member 23. When in the first position, the proximal end of the cord 6 becomes trapped between the guide wheel 24 and the retaining wheel 28 and any rotation of the guide wheel 24 caused by pulling on the cord 6 results in both wheels being driven in opposite directions by the cord 6, as is illustrated in FIGS. 9A to 9C. As the wheels rotate, their eccentricity increases the interference on the cord 6, i.e. the gap between the guide wheel 24 and retaining wheel 28 decreases. Eventually, the interference between the wheels 24, 28 and the cord 6 is so large that a tortuous path is created, and the cord 6 can no longer travel in that direction. When this occurs, the shade cannot be operated. The cord 6 locking is effective in both directions and reversing the direction of movement of the cord 6 will only briefly allow the cord 6 to move. After a short distance, the locking function described will occur again. Furthermore, in this first position, the tensioning device 1 cannot be defeated, for example by applying simultaneous hand tension and a pulling action to the cord 6 (by pulling cord towards the user) to lift the spring-loaded guide 19 away from the retainer, as the guide 19 is locked in position by the first locking pin 43 being engaged in the first receiving aperture 47 of the rear housing 13.

To cease contact with the eccentric retaining wheel 28, and free the cord 6, the guide 19 needs to move away and this transition from the first position (cord locked) to the second position (cord is free) and this can only be achieved by releasing the first locking pin 43 from the body such that the guide 19 can then be lifted, and tension then reapplied to the cord 6.

In a further embodiment of the tensioning device 1, the locking device for locking the guide 19 and body 9 in the first position is in the form of a pawl (not illustrated) which is formed as part of the guide 19 and a matching ratchet (toothed) structure (not illustrated) formed as part of the body 9, for example the front or rear housing 11, 13. The pawl and ratchet combination advantageously permits movement of the guide 19 towards the retainer as the operating element stretches but restricts reverse movement of the guide 19 away from the retainer hence reducing lateral movement of the operating element during normal operation.

In another embodiment of the tensioning device 1, the pawl and ratchet combination can be used as an alternative to the one or more locking pins to facilitate the same locking function as the one or more locking pins when the operating element has lost tension. The locking pin 43 and the ratchet-pawl combination can also be used alone or in combination.

The tensioning device 1 described herein advantageously automatically locks the spring-loaded guide 19 in the absence of operating element tension and traps the operating element between the guide 19 and retainer thus preventing operation of the blind. This entrapment of the operating element (cord 6 or beaded chain 5) between the guide 19 and the retainer when the guide 19 is in the first position can be achieved via a locking device having i) one or more locking pins engaging with corresponding receiving apertures, ii) a pawl and ratchet combination or iii) a combination of both i) and ii). In the single locking pin form, when the tensioning device 1 is installed properly, the first locking pin 43 is retracted, the spring-loaded guide 19 is free to move within the body 9 and provide tension to the operating element as intended. In the event of tension loss, the guide 19 will be pushed downward (to full extension) until the first locking pin 43 engages the first receiving aperture 47 in the rear housing 13 of the body 9 and arresting guide movement, resulting in the operating element being trapped, and preventing operation of blind. In this condition, it is not possible to defeat the locking feature. To unlock (reset) the tensioning device 1, the user must reposition the tensioning device 1 such that the operating element is reinstalled under tension. The first locking pin 43 must be depressed to release the guide 19 and the tensioning device 1 must be pulled downward to reapply tension to the operating element before remounting the device 1 to a fixed structure. The first locking pin 43 can only be accessed (depressed) if the tensioning device 1 is removed from its mounting, thus forcing the user to remove and reinstall the tensioning device 1 with proper tension.

Although the tensioning device 1 has been described with reference to a vertically orientated mounting, the tensioning device 1 could instead for example, be mounted horizontally anywhere along the length of the operating element with another fixing/tensioning device provided at a lower end of operating element.

Modifications and improvements to the invention will be readily apparent to those skilled in the art. Such modifications and improvements are intended to be within the scope of this invention. For example, the retainer and/or the body 9 instead of the guide 19 may incorporate the one or more locking pins for locking the guide 19 in the first position and the one or more receiving apertures for the locking pins may be incorporated in the guide 19 instead of the body 9.

What is claimed is:

1. A tensioning device for a looped operating element of an architectural covering, the tensioning device being configured to selectively lock the operating element in a position relative to the tensioning device, the tensioning device comprising:
a body configured to house one end of the looped operating element, the body being mountable to a fixed structure adjacent the architectural covering,
a guide adapted to receive thereabout said one end of the looped operating element, the guide being configured to move relative to the body between first and second positions;
a retainer configured to prevent said one end of the looped operating element from traveling about the guide,
a biasing element for biasing the guide towards the retainer to tension the looped operating element,
wherein in the first position, the looped operating element has no tension and the guide is extended to trap said one end of the looped operating element between the guide and the retainer to prevent travel of the looped operating element about the guide, and in the second position, the looped operating element is tensioned with the guide being retracted from the retainer, and
a locking device for locking the guide in the first position when the looped operating element has no tension such that the guide cannot be retracted away from the retainer to allow operation of the operating element.

2. A tensioning device as claimed in claim 1 wherein the locking device comprises a first locking pin housed within a recess of the guide, and the body comprises a first receiving aperture, the first locking pin being configured to project into the first receiving aperture when the guide is in the first position to lock the guide relative to the body.

3. A tensioning device as claimed in claim 2 wherein the first receiving aperture extends through a rear housing of the body, the first locking pin being releasable from the first receiving aperture by pushing the first locking pin from a rear of the body out of the first receiving aperture thereby releasing the guide from locked engagement with the rear housing.

4. A tensioning device as claimed in either claim 2 or 3 wherein the locking device includes a second locking pin housed within the recess of the guide, and the body comprises a second receiving aperture, the second locking pin being configured to project into the second receiving aperture when the guide is in the first position to lock the guide relative to the body.

5. A tensioning device as claimed in claim 4 wherein the second receiving aperture extends through a front housing of the body, the second locking pin being releasable from the second receiving aperture by pushing the second locking pin from a front of the body out of the second receiving aperture thereby releasing the guide from locked engagement with the front body.

6. A tensioning device as claimed in claim 3 wherein the rear housing is mountable against the fixed structure such that in use, the first receiving aperture is hidden from view and is not accessible to a user.

7. A tensioning device as claimed in claim 2 wherein the locking device further comprises a spring member within the recess, the spring member being configured to bias the first locking pin towards the first receiving aperture.

8. A tensioning device as claimed in claim 4 wherein the locking device further comprises a spring member within the recess, the spring member being configured to bias the first locking pin towards the first receiving aperture and bias the second locking pin towards the second receiving aperture.

9. A tensioning device as claimed in claim 5, wherein the retainer is mounted to the body between the rear housing and a front housing of the body.

10. A tensioning device as claimed in claim 1, wherein the locking device comprises a pawl formed as part of the guide and a toothed structure formed as part of the body, the pawl being configured to pass over the toothed structure when the guide moves towards the retainer to maintain tension in the operating element as the operating element stretches in use, the toothed structure restricting reverse movement of the guide away from the retainer.

11. A tensioning device as claimed in claim 1, wherein the operating element is a beaded chain and the retainer is a member comprising a trench that is sized and configured to receive the chain, the trench having a narrowing region for supporting links between adjacent beads when the guide is in the first position to prevent travel of the beaded chain.

12. A tensioning device as claimed in claim 1, wherein the operating element is a cord and the guide includes a rotatable component mounted to a main body of the guide, the rotatable component being configured to receive thereabout said cord, and wherein the retainer is a rotatable element mounted to the body, the rotatable element and rotatable component being configured to grip the cord therebetween when the guide is in the first position to prevent travel of the cord.

13. A tensioning device as claimed in claim 12 wherein the rotatable component is an eccentric guide wheel rotatably mounted to the main body of the guide and the rotatable element is an eccentric retaining wheel rotatably mounted to the body.

14. A tensioning device for a looped operating element of an architectural covering, the tensioning device being configured to selectively lock the operating element in a position relative to the tensioning device, the tensioning device comprises:
a body configured to house one end of the looped operating element,
a guide mounted to the body and adapted to receive thereabout one end of the looped operating element,
a retainer configured to prevent said one end of the looped operating element from traveling about the guide, the retainer being mountable to a fixed structure adjacent the architectural covering, the guide and body being configured to move relative to the retainer between first and second positions;
a biasing element for biasing the guide towards the retainer to tension the looped operating element,
wherein in the first position, the looped operating element has no tension and the guide traps said one end of the looped operating element between the guide and the retainer to prevent travel of the looped operating element about the guide, and in the second position, the looped operating element is tensioned with the guide being moved away from the retainer, and
a locking device for locking the guide and body in the first position when the looped operating element has no tension such that the guide cannot be moved away from the retainer to allow operation of the operating element.
